(19) United States
(12) Patent Application Publication
(10) Pub. No.: US 2004/0135880 A1
(43) Pub. Date: Jul. 15, 2004

(54) Integrated televised meeting procedure

(76) Inventor: George R. Royer, Toledo, OH (US)

Correspondence Address: George R. Royer, Attorney at Law, Suite 416, 316 N. Michigan Street, Toledo, OH, 43624, US

(21) Appl. No.: 10/340,344

(22) Filed: Jan. 13, 2003

(51) Int. Cl. H04N 7/14

(52) U.S. Cl. 348/14.08; 348/14.09

(57) ABSTRACT

The subject invention comprises a physical process means for televised meeting of individuals who are located at different locations, as based on standardized studio features for identical background imaging for the different studios that are substantially identical in fixtures, furniture, and spatial placements from at least one visual viewpoint so that when the simultaneous televised images are superimposed on a common viewing screen, the individual participants appear to be positioned simultaneously in the same studio at predetermined locations.

### DISCUSSION OF PRIOR ART AND BACKGROUND OF INVENTION

The subject invention relates to a televises or photographic imaging of multiple individuals or objects located in diverse geographic locations in such a manner so as to pictorially portray such individuals as being in the same location in such pictorial or photographic portrayal. In this respect, such uniform portrayal of individuals at a centralized location may have more than mere aesthetic considerations, as the uniform portrayal of various individuals located at diverse locations, may have certain utilitarian effects. This aspect is further discussed below.

More directly and specifically, in the case of a trial there is usually a bench for the judge, at which bench the judge should be seated, a seat for the witness, at which the differently located witnesses could be photographed or televised with the image of the witness presented as if the witness is actually seated at the witness chair. Further, a podium may be used and shown at which the questioning attorney could be photographically shown as being present, even though such attorney may be located at still another location. By such an integrated presentation of all the participants, from different locations, on a common screen as if all were in the same room location, trials could be conducted without the necessity and concomitant expense of witness travel to a central location. This integrated presentation on a viewing screen is envisioned as presenting a panoramic view of all participants as if they were all actually occupying the same room simultaneously exchanging the necessary verbal communications. The advantage of such a system would enable the participants to actually view each other in the process, which in certain circumstances in legal proceedings is a recognized due process requirement.

The application of such a system is not limited to legal proceedings and can be applied also to any type of meeting where viewing of the participants is either essential or practical. An example of such meeting requirements involving diversely located individuals is myriad.

In this area of the prior art, televised monitoring with sound reproduction of meting participants at different geographic locations is well known. In this present circumstances there is no showing or integration of the individuals as if they were all located in the same room at a predetermined fixed position. The disadvantages of the existing practice is obvious, as discussed above, and is particularly salient in the case of legal proceedings where it is optimal to be able to view any or all participants simultaneously. This latter aspect would be particularly viewed as advantageous if a jury would be requested to view the legal or trial proceedings on a screen and one or more jurors opt to simultaneously view the questioning attorney as well as the witness.

In view of the foregoing limitations of television monitoring of individuals at diverse locations, the subject invention is conceived as a system to provide the capability to have an integrated viewing of diversely located individuals on a single frame and screen. Accordingly, the following purposes and objects of the subject invention are directed accordingly.

### OBJECTS OF THE INVENTION

It is an object of the subject invention to provide an improved procedure for photographically representing diversify located individuals on a single viewing screen.

Another object of the subject invention is to provide an improved apparatus and system for demonstrating and showing diversely located individuals as if present in the same room simultaneously.

A further object of the subject invention is to provide an improved system of television proceedings of any type involving individuals.

Still another purpose of the subject invention is to provide an integrated system of televising individuals from different locations and presenting them visually on a single screen.

Yet another purpose of the subject invention is to provide an integrated system of televising individuals from different locations and presenting them visually on a single screen.

A further object is to provide a more effective and efficient mechanism for televising diversely located individuals

Other and further objects of the subject invention will be apparent from a reading of the description taken in conjunction with the claims.

### DRAWINGS

FIG. 1 is a top elevational view of the structural arrangement of a room incorporating features of the subject invention;

FIG. 2 is a top elevational view of the overall structural arrangement of a room with individuals shown in FIG. 1 except one or more participants;

FIG. 3 is a top elevational view of a room identical, in part, to the room in FIG. 1 with a participant shown, as located at a distance from the room shown in FIG. 3;

FIG. 4 is a frontal elevational view of the first room in which the subject trial is being conducted;

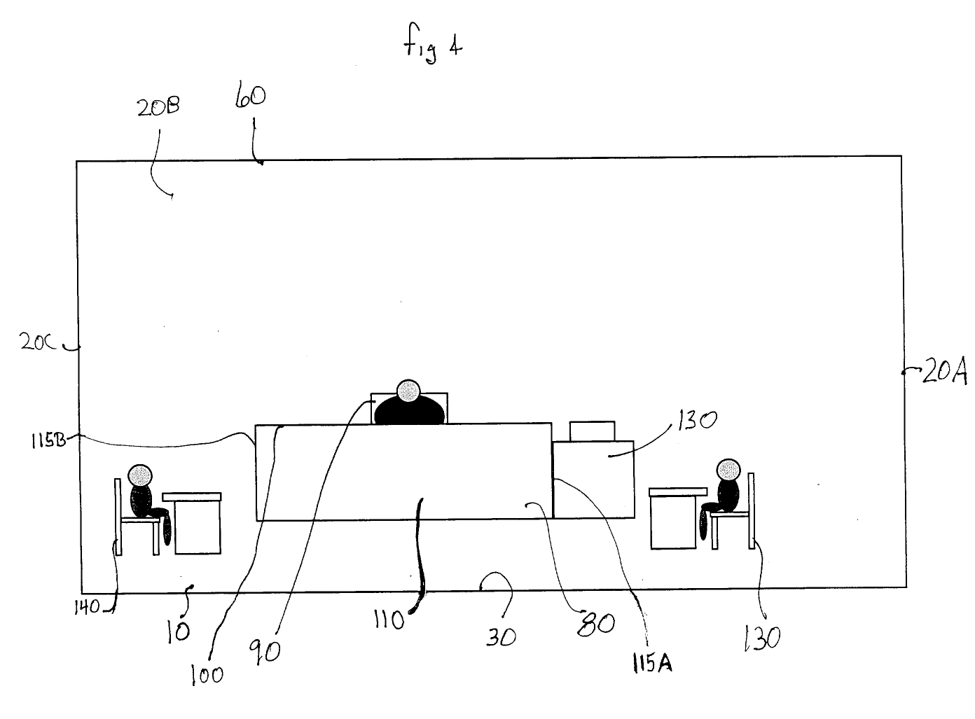

FIG. 5 is a frontal elevational view of the second room in which a distant witness is situated;

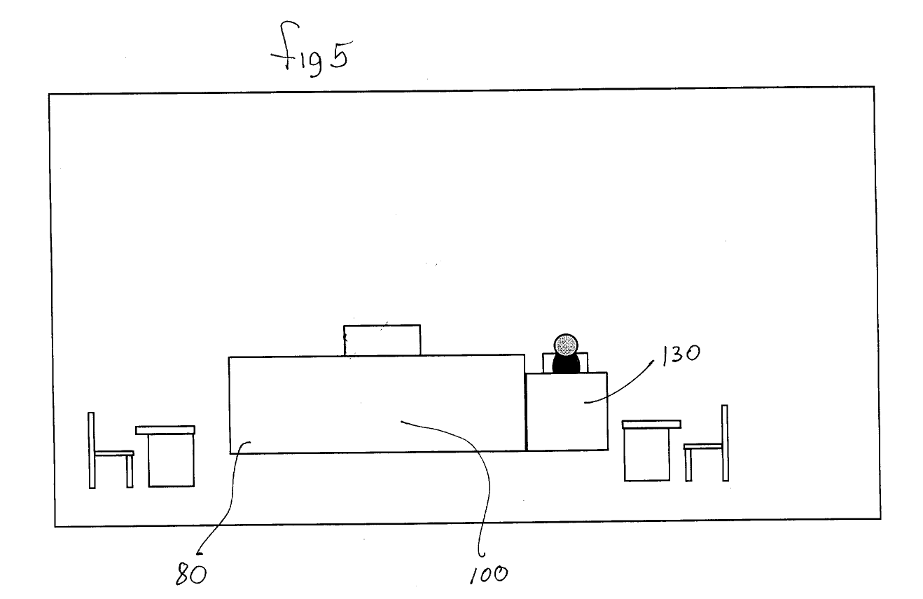

FIG. 6 is a composite televised view of the all the rooms as embodied in FIGS. 4 and 5.

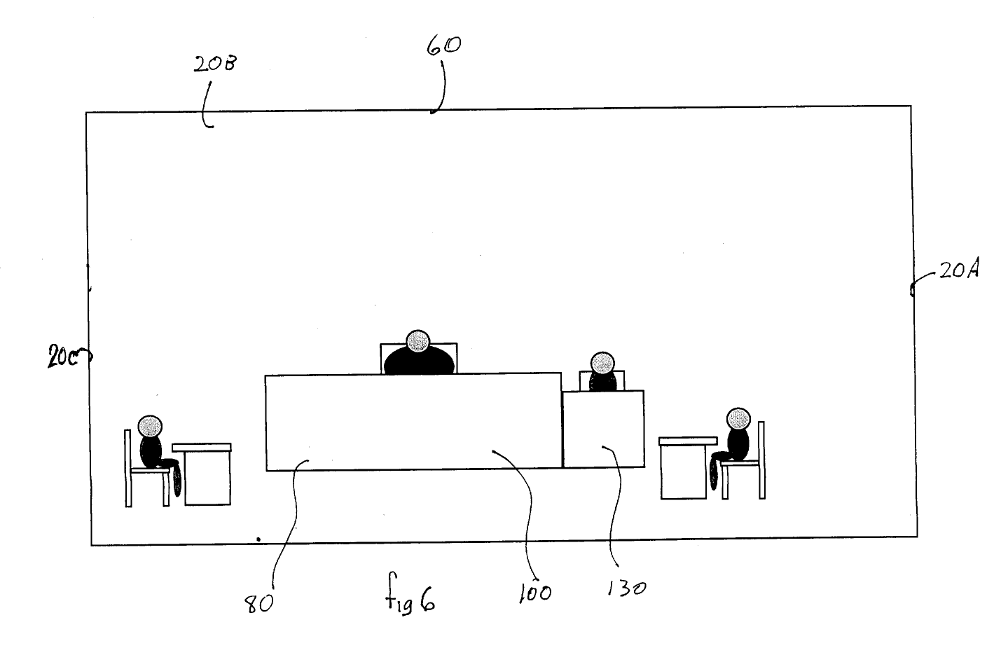

### DESCRIPTION OF GENERAL EMBODIMENT

The subject invention comprises a physical process means for televised meeting of individuals who are located at different locations, as based on standardized studio features for identical background imaging for the different studios that are substantially identical in fixtures, furniture, and spatial placements from at least one visual viewpoint so that when the simultaneous televised images are superimposed on a common viewing screen, the individual participants appear to be positioned simultaneously in the same studio at predetermined locations.

In summary, the subject invention involves a combined process and structure whereby television images of different subjects at different locations can be taken and subsequently such separate television images can be superimposed on a common screen to project a final overall image of all separate images as if the subjects are together at one location. In order to effectively superimpose such separate images as a final realistic: image, each differently located studio has similarly appearing furniture or backgrounds that are uniformly located from one another, at least from one similar viewing aspect, all of which photographed results are televised simultaneously and superimposed on a viewing screen or several viewing screens simultaneously which can then be seen by all participants simultaneously in all the separate rooms or studios.

### DESCRIPTION OF PREFERRED EMBODIMENT

In describing the following discussed preferred embodiment of the subject invention, it must be stressed that a description of only one such embodiment shall not be considered as limiting the scope of the subject invention as set forth in the following description and claims. Moreover, it is important to indicate that while the following description of a preferred embodiment of the subject invention is directed and discussed on a courtroom scenario, the scope of the subject invention is not so limited.

Referring now to the drawings in which one arrangement of the subject invention is shown, set forth is an upper elevational of a viewing studio 10 which is adapted as the basic focal aspect in the arrangement and processes used to implement the subject invention. In this respect, as stated above, the main directional thrust and application of the subject invention discussed herein is directed towards a courtroom wherein multiple individuals participate in a hearing or trial. However, use of the subject invention to other types of proceedings is envisioned within the scope of the subject invention.

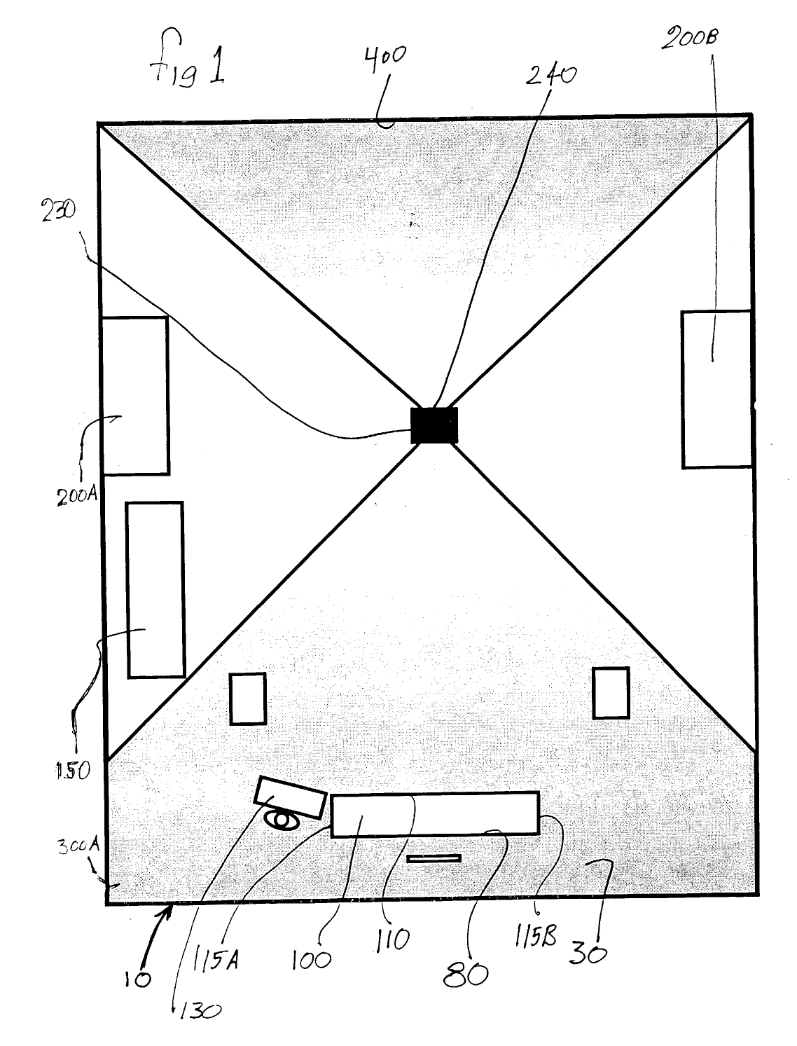

To the end that the a primary focus of the subject invention is directed to a legal proceeding in a courtroom, the studio 10 is structured as courtroom having conventional features for a courtroom setting. Specifically, as stated above, the studio 10 is shown in FIG. 1 as a upper elevational view as if looking downwardly on the courtroom from directly above. Such an upper elevational view provides the most optimal view for a basis of describing the physical aspects of the subject invention and procedural concepts involved. As seen in FIG. 1, the studio is enclosed by flanking vertical walls 20A, 20B, 20C and 20D which flanking walls form a rectangular room enclosure configuration, which is generally conventional. A room of any configuration may be used in conjunction with the subject invention, thus the wall structure may be other than vertical or rectangular as described. Between the vertical walls 20a, 20B, 20C, and 20D is designed a flooring member 30 on which various furniture items or fixtures are placed in room 10. Each objects as discussed below may be either integrated to the floor or simply resting unattached to the upper surface of the floor 30. The walls 20A, 20B, 20C, and 20D may be arranged in any direction, number, or disposition. A door 40 is provided for access to the room, although multiple doors -may be used in conjunction with the room 10. Moreover, the room 10 would optimally have a ceiling 60 to complete the enclosure of the room.

In the preferred embodiment of the subject invention, room 10 is equipped with a judge's bench 80, which is for all practical purposes and applications an enlarged elongated desk behind which is placed a chair 90 for the judge to sit when presiding at a legal proceeding such as a trial or hearing. The bench 80 has an upper surface 100 and a front surface 110 and a vertical side surfaces 115a and 115B, and such surfaces are shown as being generally rectangular, as seen from a frontal view. The bench 80 is generally and optimally placed adjacent or close to one of the walls in the room. In the representation shown in the drawings, the bench 80 is arbitrarily placed lengthwise in a parallel position to wall 20A. Moreover, the wall where the judge's bench is located is generally referred to as the front of the room. By such latter arrangement, the judge or hearing officer is placed or positioned to face towards the larger interior space of the room 10.

Further placed in room 10 is a witness chair 130 for a witness to sit and testify. Witness chair 130 is usually situated to the one side of the bench 80, shown as being adjacent side 115A of the bench in the drawings. In some courtrooms, the witness chair 130 is formed as an integral extension of the bench 80, and is so in the preferred embodiment of the subject invention, as seen in FIG. 1. The precise placement of the witness chair is not critical to the subject invention, however.

Moreover, disposed in a position near the witness chair 130 is a chair 140 for the court reporter as seen as being located near the witness chair 130 so that the witness can be observed by the court reporter while testifying. Further disposed in the room 10 is a jury box 150 having a plurality of seats arranged to hold jurors during a trial proceeding. The jury box 160 is preferably but not necessarily aligned along a wall portion off to the side of the bench, as seen in FIG. 1. Yet another usual fixture in the room is a speaker's podium 160 at which an attorney stands while questioning witnesses. Still other features involved in the subject room 10 are attorney tables 170A and 170B positioned respectively for both defense counsel and plaintiff's counsel to sit with their respective clients. Another feature usually present in a courtroom are spectator seats 200A, 220B. . . . In the usual arrangements of a courtroom, such spectator seats are generally located in the back of the room; however, in the subject invention the spectator seats are preferably, but not essentially, located along one the side walls 20B and 20D for the reasons more fully described below. Additionally, other functional furniture members may be placed in the room 10.

There are two additional components in room 10, namely a television camera, 230, a television projector 240, and a viewing screen 400 to receive images projected from television projector 240, preferably but not essentially to viewing screen 400 is positioned in the back of the room 10 at that back of diversely located rooms 300A and 300B, as more fully described below. This position of the viewing: screen 400 is not critical as stated. The functions and interrelationships of these three diverse rooms 10, 300A and 300B will be more fully discussed below. It is important to note that the television camera 230 be positioned in the same location in each room 10, 300A and 300B for viewing purposes, but this is not critical if there are scaling modifications in each room, or other compensatory means used to ensure uniform transmission of a base image.

In short, the subject invention may be made applicable and utilized in rooms of any configuration, whether rectangular or otherwise, so long as the specified parameters, as discussed below, are utilized. Moreover, the subject invention is not just limited to courtrooms and may be applied to other functional rooms.

As stated above, in describing the arrangement, fixtures, furniture and television equipment used an placed in the subject room 10, as more fully descried below, is to be understood that a plurality of such rooms, such as room 10 and studios 300A, 300B . . . will be utilized in this endeavor. It is further understood that these multiple studios or room will be identical, from at least one common visual viewpoint as to the location, spacing, dimensions, shape of the furniture and fixtures disposed in each such room 10, 300A and 300B, as described above all relative to the television camera disposed in each such room. This common visual viewpoint is shown in FIGS. 1, 2, and 3, as being from television camera 230 directed towards the front wall 20B of the room for each room 10, 300A and 300B as shown in gray as the radially emanating arc “X” in each room. This substantial viewing identity and substantially precise positioning, sizing, structure of such furniture and fixtures from this common viewpoint will enable the ultimate goal of an integrated representation of all the individual participants on a viewing screen which will be available at each of the various room locations. Also significant is the explicit aspect that by equipping room 10 and similar rooms 300A, 300B . . . in substantially identical fashion from the viewpoint of the camera view X, all the furniture and fixtures as to placement, spacing and other structural attributes as described above will appear the same in the final composite viewing with the participants at their respective geographic locations in rooms 10, 300A, 300B, . . . thus, when the diversly located individuals are photographically televised in their respectively assigned positions in such diversely located rooms, all the individuals will appear on the final integrated image on the viewing screen in each room, if each individual was sitting in their respectfullly designated positions, as if all were in the same room. Alternatively all participants from their diverse locations in such similar rooms 10, 300A and 300B . . . will appear on such integrated composite image in their specific positions on the viewing screens at all locations.

It is to be noted that the room 10 and rooms 300A, 306B . . . need not have identical features for those portions of the respective rooms and studios that fall behind the visual arc “X” of camera 230 since they will not be photographed in this process. More specifically, visual images behind the viewing “X” will not be relevant.

As stated above and as shown in the drawings, in the preferred embodiment, a viewing screen 400 in room 10 is aligned flush on the rear wall 20D in room 10 as being appended thereto and aligned parallel to the planer surfaces of the wall 20D as a fixture preferably but not essentially attached to the wall or otherwise positioned in such aligned arrangement. Other positions can be used for the screen 400 so long as the screen can be viewed by the attorneys, judge, jurors and other key participants or observers in the proceedings. Thus, as explained above, the optimal position of the spectator seats is along the sides so that the spectators can observe screen 400 the back of the room 10, along back wall 20D as well as observe the front of the room 10. Swivel seats may be appropriately positioned for the jurors, spectators, attorneys' table seats, and other courtroom participants.

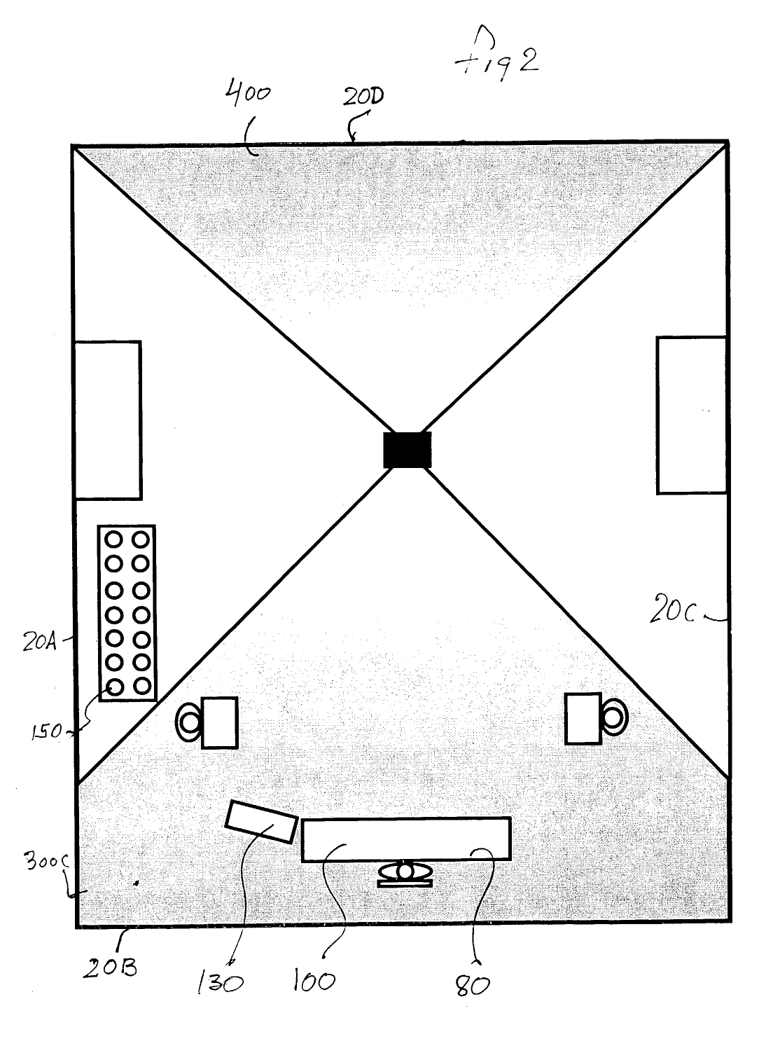

In the preferred embodiment of the subject invention, it is important to emphasize that the concepts herein can utilized if one or more diversely located studio rooms 300A, 300B . . . in addition to room 10 are available at different locations. As stated, it is important that each such diversed located rooms have substantially identical fixtures and features as described above at least in the viewpoint of the viewing arc of the camera 230. More particularly, it is preferable and somewhat essential that in each such separate studio 300A, 300B . . . all items and fixtures such as the separate judge's bench 80 be identical to each other in size and configuration, from the frontal viewpoint of the viewing area the front surface 90 of the bench and the upper surface 95; and that such bench be placed in the identical position in each separate room, that is the same distance from the wall 20A and the same distance from the rear wall 20C or the viewing screen 40. As for the lateral walls 20B and 20C, in some situations these lateral walls may not be necessarily the same distance from each other in each room so long as the commonly placed television cameras are structured and adapted as more fully discussed below to pick up the same angular sweep, as more graphically and schematically demonstrated in FIGS. 1 and 2.

As to the television camera 230 for purposes of implementing this invention it is preferably placed in a central position of the room 10, such television camera being disposed to capture the images of the room from the television camera forward to the front wall 20A with viewing arc “X” as described. By such positioning the television camera 230 is intended to collectively photograph the judges, bench, podium, the witness chair, and possible the respective counsel tables with a visual arc “X”. Projector 240 in room 10 then projects the resultant image on two screen 400 in room 10.

As to the images captured on television in room 10, as above indirected similarly placed television cameras 500, and 600 are situated in the other room 300A, 300B . . . such similar positions being preferably identical to the location of the camera 230 in room 10. Based on the foregoing discussion, each camera 500 and 600 in rooms 300A and 300b . . . will simultaneously capture identical images as they are focused towards each front wall of such studios 300A and 300B. Now as individuals take positions in the respective room, the images of the individuals in each room will be different in the rooms 10 or studios 300A, 300B, for example an individuals will be in their respective positions such as the individual in room 300A who will take the witness stand, and possibly be the only individual in room 300A for example, and so forth.

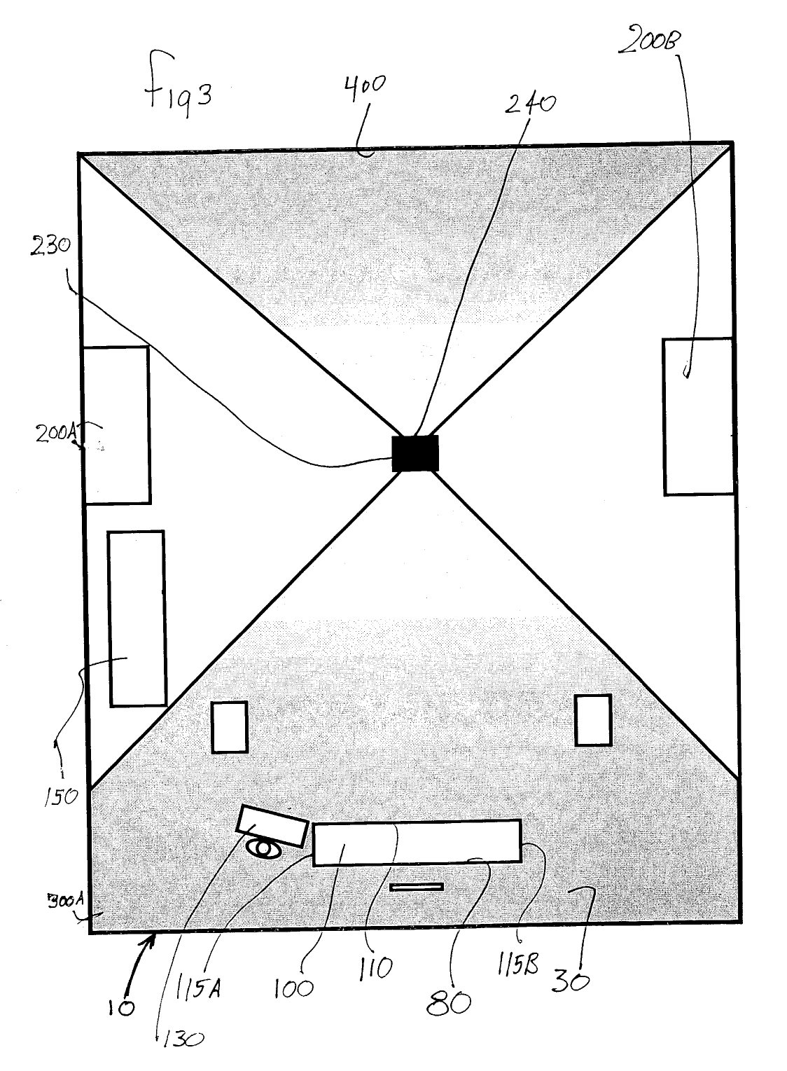

As can be seen from FIGS. 2 and 3 the rooms 300A and 300B have in addition to television cameras 500 and 600 respectively projectors 700 and 800 respectively. Projectors 400, 700, and 800 respectively in rooms 10, 300A, and 300B are adapted to project the total superimposed images of the views captured by camera 230, 400, and 500 in rooms 10, 300A, and 300B. For this integrated, composite projection process rooms 300A and 300B have viewing screens 850 and 900 respectively, which viewing screens are similar to viewing screen 400 in room 10.

Thus when the diverse participants in the various rooms used, whether just two or more, the various cameras will in each room capture a different image in at least to the individual participant each case and the projectors associated therein will project a total unified image.

For implementation this described procedure each room will be linked in some electronic fashions though telephone lines or other electronic communication means to feed back and forth between the various room locations respective televised images captured in each room. Theses electronically photographed images as mutually transferred to each room from one another will be entered into electronically or other based processor 950A, 950B, and 90C in each room, 10, 300A, 300B respectively which are preferably digital processions which will collect the images captured from each room and superimpose each image simultaneously, and the resultant superimposed images are then electronically fed into the respective projectors 240, 500, and 600 in each room so that the resultant superimposed images can be projected into the respective screen in each room.

It is to be stressed that features of the subject invention may be utilized in other than rectangularly configured rooms and other than as described above.

1. A process televising simultaneously adapted to accommodate individuals a plurality of building rooms for combining each resultant televised view on viewing located in said room comprising:
a. a front room having front room having a given shape and size fixtures therein adapted to accommodate individuals that are positioned in a given disposition within a portion of said room;
b. a second room having second room fixtures therein adapted to accommodate individuals that are positioned in said second room, said second room located at a different geographic area than said second room, said second room having second room fixtures positioned in a substantially identical position to the first room fixtures positioned in first room and having substantial identical shape and size herein, said second room fixtures having a shape;
c. projection means located in each room to televise the images of the respective fixtures located in each such room will as the individuals located in the first room and the second building room;
d. screen means located in each said building room to receive the images of both cameras means.

2. A system for videotaping simultaneously plurality of diverse locations with individuals at such diverse locations to superimpose resultant images of the diverse locations to represent all the individuals as if they were at the same location comprising:
(a) plurality of diverse locations, each of the locations having features identical in shape, color, size, spacing, positioning so that each diverse location has an identical appearance from at least common viewing one perspective common to all such locations;
(b) videotaping means disposed in each of said diverse locations, each videotaping means being disposed at the same relative location at each of said diverse locations with each of said videotaping means being directed towards the same common viewing perspective in each said location;
(c) image receiving screen means located in each of said diverse locations, each said projection means being adapted to receive videotaping images, each such image projection means located in same position in lieu of said diverse locations;
(d) receiver means adapted to receive each of said images from each of said diverse locations;
(e) projection means adapted to project each of said images on said screen.

3. A multiple studio arrangement for simultaneously telecasting of images of objects and individuals located at separate locations adapted for superimposition of the separately located images and persons on a single viewing screen for integrated viewing of such images and persons comprising:
a. a plurality of studios, each such studio having a viewing position following common characteristics:
i. substantially identical objects functioning as furniture and background fixtures, said object having identical dimensions, features, as viewed from the viewing position;
ii. said objects and fixtures having identical spacing from one another in each studio and;
iii. said objects being positioned to face in the same direction;
b. camera means located at the same position in each room at a distance from the objects and fixtures;
c. viewing screen.
